(19) United States
(12) Patent Application Publication
(10) Pub. No.: US 2007/0153551 A1
(43) Pub. Date: Jul. 5, 2007

(54) Conductive fixed structure of track light

(76) Inventor: Hua-Rung Chiu, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/324,325

(22) Filed: Jan. 4, 2006

(51) Int. Cl. H01R 33/00

(52) U.S. Cl. 362/648

(57) ABSTRACT

A conductive fixed structure of track light includes a track, an insulation strip, two conductive strips and a lamp. Wherein the track includes two lateral sidewalls opposing each other, a receiving groove is formed between the two lateral sidewalls. An insulation strip is disposed in the receiving groove. The insulation strip is disposed in the receiving groove, the insulation strip has a first receiving groove and second receiving groove. The two conductive strips made of conductive materials, and the conductive strips are disposed in the first receiving groove and second receiving groove of the insulation strip. The lamp includes a fixed member, a rotatable member and a fasten member, the fixed member has a first electrode and a second electrode. Wherein the track is disposed into the opening, thereby the first and second electrode electrically is connected to the two conductive strips.

### BACKGROUND OF THE INVENTION

1. Field of the Invention

The present invention relates to a structure of track light, and more particularly, to a track light with conductive fixed structure.

2. Description of Related Art

Track lights provide not only lighting but also decoration. Track lighting includes a track light assembly combined with lamps, and is widely used in various applications.

Referring to FIG. 1, a conventional track light assembly adopted for a track light 10 discloses a track structure 7, two insulation strips 8, and two conduction strips 9. The track structure 7 has two engaging slots 70 formed in two lateral sides thereof to accommodate the two insulation strips 8 therein. The two insulation strips 8 include two clamping recesses 80 for receiving the two conduction strips 9 sandwiched therein. The track light 10 includes two clipping arms 101 and two connection members 102 screwed on upper portions of the two clipping arms 101, respectively. The two connection members 102 are engaged with the conduction strips 9, respectively, to secure the track light 10 the track structure 7. The two conduction strips 9 provide positive and negative power sources to the track light 10 via the two connection members 102, respectively.

Obviously, the conventional track light assembly provides a complicated structure, and track light 10 is correspondingly as complicated as the conventional track light assembly. Thus, the costs, the weight, and the space the conventional track light assembly occupies increase accordingly. The track light 10 must be manually mounted in the track structure 7, and members in the combination drop off easily. Furthermore, the track structure 7 is decorative only and lacks further application.

Accordingly, as discussed above, the prior art still has some drawbacks that could be improved. The present invention aims to resolve the drawbacks in the prior art.

### SUMMARY OF THE INVENTION

An objective of the present invention is to provide a conductive fixed structure of track light, the fixed member connected to rotatable member by the fasten member to form opening, the track is disposed into the opening, thereby the first and second electrode electrically connected to the two conductive strips.

For reaching the objective above, the present invention provides a conductive fixed structure of track light includes a track including two lateral sidewalls opposing each other, outside of the two lateral sidewalls having a guiding groove respectively, a receiving groove formed between the two lateral sidewalls; an insulation strip disposed in the receiving groove, the insulation strip having a first receiving groove and second receiving groove; two conductive strips made of conductive materials, and the conductive strips disposed in the first receiving groove and second receiving groove of the insulation strip; and a lamp including a fixed member, a rotatable member and a fasten member, the fixed member having a first end and a second end, the first end pivoted to the rotatable member, the second end connected to rotatable member by the fasten member to form opening, the fixed member having a first electrode and a second electrode; wherein the track disposed into the opening, thereby the first and second electrode electrically connected to the two conductive strips.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of the conventional track light assembly;

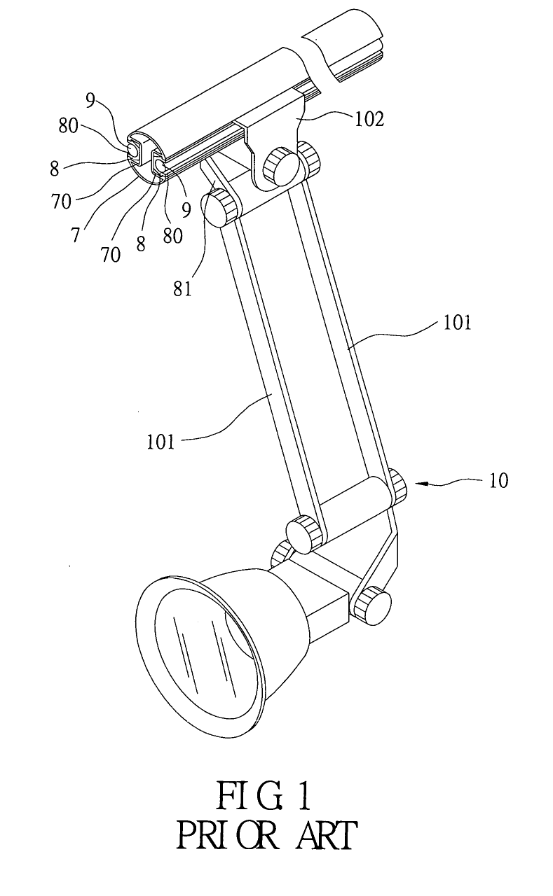

FIG. 2 is a decomposition view of a conductive fixed structure of track light of the present invention;

FIG. 3 is a perspective view of a conductive fixed structure of track light of the present invention (1); and

FIG. 4 is a perspective view of a conductive fixed structure of track light of the present invention (2).

### DETAILED DESCRIPTION OF PREFERRED EMBODIMENTS

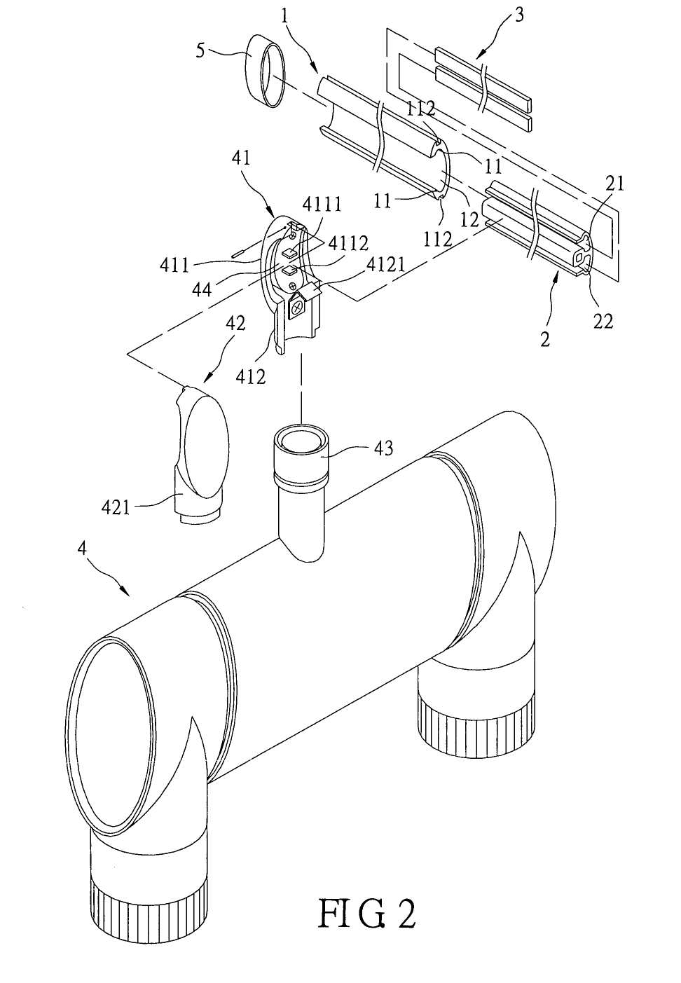

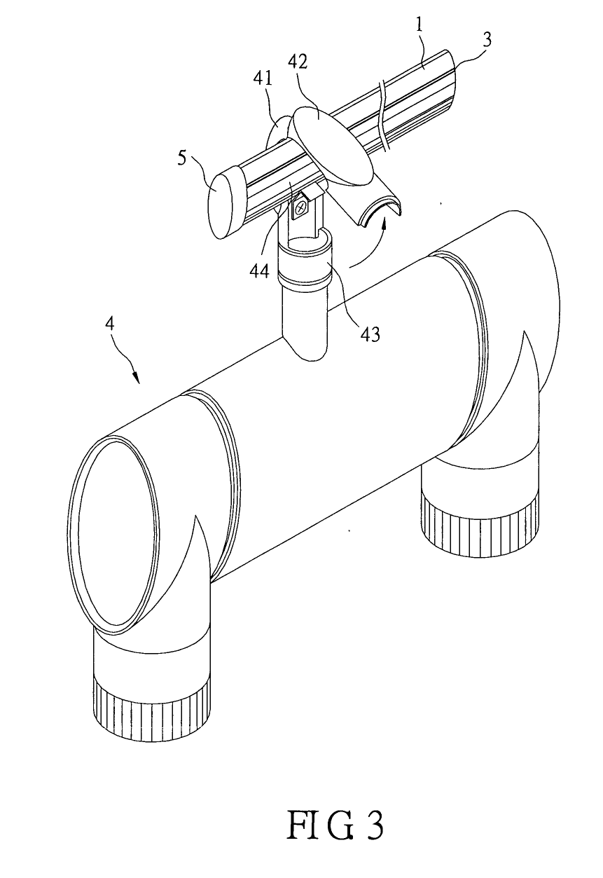

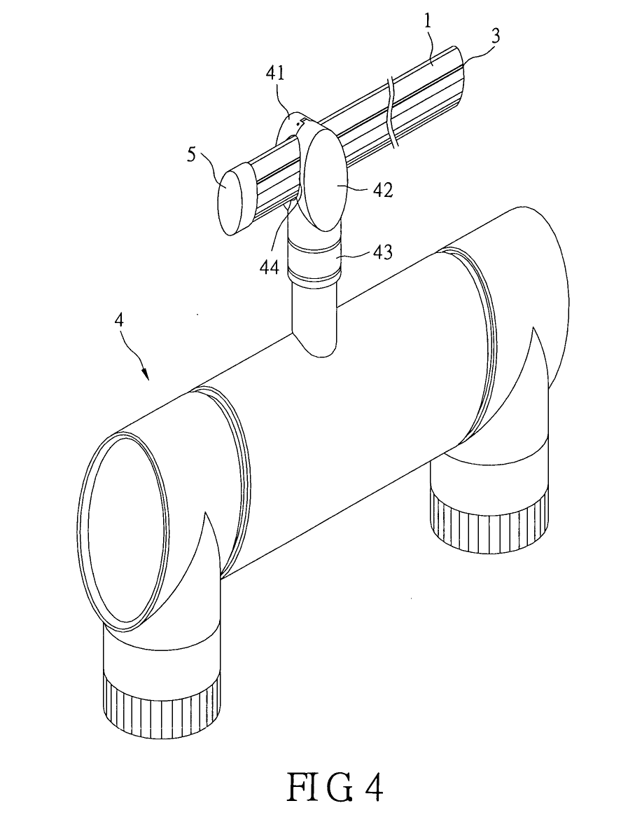

Referring FIG. 2 to FIG. 4, which is a conductive fixed structure of track light includes a track 1, an insulation strip 2, two conductive strips 3 and a lamp 4. Wherein the track 1 includes two lateral sidewalls 11 opposing each other, outside of the two lateral sidewalls 11 have a guiding groove 112, a receiving groove 12 formed between the two lateral sidewalls 11. An insulation strip 2 is disposed in the receiving groove 12. The insulation strip 2 is disposed in the receiving groove 12, the insulation strip 2 has a first receiving groove 21 and second receiving groove 22. The two conductive strips 3 made of conductive materials, and the conductive strips 3 are disposed in the first receiving groove 21 and second receiving groove 22 of the insulation strip 2. The track 1 further includes two insulation cover covered on the two sides thereof.

The lamp 4 includes a fixed member 41, a rotatable member 42 and a fasten member 43, the fixed member 41 has a first end 411 and a second end 412, the first end 411 is pivoted to the rotatable member 42, the second end 412 is connected to rotatable member 42 by the fasten member 43 to form opening 44, the fixed member 41 has a first electrode 4111 and a second electrode 4112. Wherein the track 1 is disposed into the opening 44, thereby the first 4111 and second electrode 4112 electrically is connected to the two conductive strips 3. The fixed member 41 has a grounding portion 4121 disposed on lower edge thereof. The rotatable member 42 has a joint portion 421 disposed on lower edge thereof, the second end 412 of the fixed member 41 is connected to joint portion 421 by the fasten member 43. The fasten member 43 is a metal ring.

The present invention is to provide a conductive fixed structure of track light, the fixed member 41 connected to rotatable member 42 by the fasten member 43 to form opening 44, the track 1 is disposed into the opening 44, thereby the first and second electrode 4111, 4112 electrically connected to the two conductive strips 3.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A conductive fixed structure of track light, comprising:
a track including two lateral sidewalls opposing each other, outside of the two lateral sidewalls having a guiding groove respectively, a receiving groove formed between the two lateral sidewalls;
an insulation strip disposed in the receiving groove, the insulation strip having a first receiving groove and second receiving groove;
two conductive strips made of conductive materials, and the conductive strips disposed in the first receiving groove and second receiving groove of the insulation strip; and
a lamp including a fixed member, a rotatable member and a fasten member, the fixed member having a first end and a second end, the first end pivoted to the rotatable member, the second end connected to rotatable member by the fasten member to form opening, the fixed member having a first electrode and a second electrode;
wherein the track disposed into the opening, thereby the first and second electrode electrically connected to the two conductive strips.

2. The structure as claimed in claim 1, further comprising two insulating cover covered on the two sides of the track.

3. The structure as claimed in claim 1, wherein the fixed member has a grounding portion disposed on lower edge thereof.

4. The structure as claimed in claim 1, wherein the rotatable member has a joint portion disposed on lower edge thereof, the second of the fixed member connected to joint portion by the fasten member.

5. The structure as claimed in claim 1, wherein the fasten member is a metal ring.
